(19) United States
(12) Patent Application Publication
(10) Pub. No.: US 2022/0006335 A1
(43) Pub. Date: Jan. 6, 2022

(54) STATOR, A MOTOR AND A VEHICLE HAVING THE SAME AND A METHOD OF MANUFACTURING THE STATOR

(71) Applicant: EMF INNOVATIONS PTE. LTD., Singapore (SG)

(72) Inventor: Chang Chieh HANG, Singapore (SG)

(73) Assignee: EMF INNOVATIONS PTE. LTD., Singapore (SG)

(21) Appl. No.: 17/428,083

(22) PCT Filed: Dec. 26, 2019
(86) PCT No.: PCT/SG2019/050638

§ 371 Date: Aug. 3, 2021

(51) Int. Cl. H02K 1/17; H02K 15/03

(52) U.S. Cl. CPC H02K 1/17; H02K 15/03

(57) ABSTRACT

A stator of an SRM is disclosed. The stator includes two or more pairs of diametrically opposite stator poles and two or more stator windings Each stator winding is wound around each pair of diametrically opposite stator poles. The winding can be energized to generate magnetic flux within one stator pole of the pair of diametrically opposite stator poles along a radial axis thereof. The magnetic flux emanates out of a face of the stator pole. The stator further includes a permanent magnet disposed in the stator pole for diverting the magnetic flux to emanate at least substantially from a side surface of the stator pole. A motor and a vehicle including the stator are also disclosed. A method of manufacturing the stator is further disclosed.

### TECHNICAL FIELD

This invention relates to a stator and a motor having the same. More particularly, this invention relates to a stator suitable for use in a switched reluctance motor.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Switched reluctance motor (SRM) is a type of stepper motor which works on the principle of reluctance torque. The SRM can be used in fuel pump operations, as well as in products including vacuum blowers, electric vehicles such as e-2-wheelers, e-3-wheelers, hybrid vehicles, electric fans, washing machines, electric power steering, electric drives used in process control industries and the like. Its varied applications are in part due to its simple design and robustness of construction with high reliability, wide-spread range, low cost, fast response, fault tolerance and high torque to inertia ratio to state a few. The major limiting features of the motor are the high torque ripple and acoustic noise which is generated on the run.

The acoustic noise of SRM motor is about 40% higher than an existing conventional motor at speeds above 7500 revolutions per minute (RPM). The current in the stator windings of the SRM interacts with the local magnetic field to produce/induce a force on the stator windings. This force could cause winding vibrations that result in the emission of acoustic noise. The winding vibrations could also excite stator vibrations that adds to the acoustic noise. The acoustic noise can be controlled by various means. One such means is the use of switches to control the current path. Another means is the use of fuzzy logic control to optimize the control of the SRM. The acoustic noise may also be due to magnetic flux reversal and flux pulsation.

Torque ripple in electrical machines is the difference between minimum and maximum torque during one revolution thereof. It is caused by many factors such as cogging torque, the interaction between the magnetomotive force (MMF) and the airgap flux harmonics etc. The main cause of torque ripple is flux pulsation. Flux pulsation cannot be eliminated but can be reduced by introducing a permanent magnet in the stator to support the initial flux during torque production and starting.

Basically, torque is the function of stator flux multiplied by electrical current in the stator windings/coil. Therefore, both stator flux and electrical current contribute to the generation of torque.

Permanent Magnets (PM) are used to reduce the flux pulsation, but the use of PM may introduce cogging or ‘no-current’ torque in motor which accordingly results in a higher starting current. Cogging torque occurs due to magnetic flux linkage with a rotor when the rotor is not rotating. External resistive bank current, auxiliary windings installed on the stator, and introduction of copper bars/damper winding in the rotor have been used to reduce this initial no-current torque due to the use of the PM. The common use of rare earth magnets for this purpose has proved to be quite expensive. There is also a risk of demagnetization of the poles due to excessive heat, large armature current or overloading of a SRM for a long period of time.

Further, as the SRMs are driven only by reluctance torque, additional excitation currents for the stator windings are needed to excite the SRM. Thus, the efficiency of SRMs is inferior to that of a permanent magnet synchronous motors used in electric vehicles. Due to torque ripple, SRMs typically have a low efficiency at lower speeds when compared to the brushless DC (BLDC) motors and a lower power density when compared with magnet assisted motors. A BLDC motor has a permanent magnet in its rotor and an electromagnet in its stator.

In light of the above, there exists a need for an improved SRM which alleviates at least one of the aforementioned drawbacks.

### SUMMARY OF THE INVENTION

According to an aspect of the present disclosure, there is provided a stator including two or more pairs of diametrically opposite stator poles and two or more stator windings. Each stator winding is wound around each pair of diametrically opposite stator poles. The winding can be energized to generate magnetic flux within one stator pole of the pair of diametrically opposite stator poles along a radial axis thereof. The magnetic flux emanates out of a face of the stator pole. The stator further includes a permanent magnet disposed in the stator pole for diverting the magnetic flux to emanate at least substantially from a side surface of the stator pole.

In some embodiments, the permanent magnet is disposed in the stator pole offset from the radial axis. And the permanent magnet has an N-pole facing the radial axis and a direction of magnetism intersecting the radial axis of the stator pole. In some embodiments, the permanent magnet has a direction of magnetism that is close to perpendicular or perpendicular to the radial axis.

In some embodiments, the permanent magnet is the sole magnet disposed in the stator pole.

In some embodiments, the other stator pole of a pair of diametrically opposite stator poles is void of any permanent magnet.

In some embodiments, the stator poles of the two or more pairs of diametrically opposite stator poles having a permanent magnet disposed therein are adjacent to one another.

In some embodiments, the permanent magnet is a non-rare earth ferrite permanent magnet.

According to another aspect of the present disclosure, there is provided a motor including the above-described stator.

According to yet another aspect of the present disclosure, there is provided a vehicle including the above-described motor. Such a vehicle includes but is not limited to e-2-wheelers, e-3-wheelers and hybrid vehicles.

According to yet a further aspect of the present disclosure, there is provided a method for manufacturing a stator. The stator includes at least two pairs of diametrically opposite stator poles. The method includes placing a winding around each pair of the at least two pairs of diametrically opposite stator poles. The winding is energizable to generate magnetic flux within a stator pole of the pair of diametrically opposite stator poles along a radial axis of the stator pole to emanate out of a face thereof. The method also includes inserting a permanent magnet in the stator pole for diverting the magnetic flux to emanate at least substantially from a side surface of the stator pole.

In some embodiments, inserting a permanent magnet includes inserting a permanent magnet in the stator pole leaving the other stator pole of the pair of diametrically opposite stator poles without any magnet.

In some embodiments, the stator poles of the at least two pairs of diametrically opposite stator poles having a permanent magnet inserted therein are adjacent to one another.

Other aspects and advantages of the invention will become apparent from the following detailed description, taken in conjunction with the accompanying drawings, illustrating by way of example the principles of the invention.

### BRIEF DESCRIPTION OF THE DRAWINGS AND FIGURES

FIG. 1 is a sectional drawing of a three-phase switched reluctance motor (SRM) according to an embodiment of the invention, wherein the SRM includes low-cost non-rare earth ferrite permanent magnets disposed in selected stator poles of the three-phase SRM.

FIG. 2 is a sectional drawing showing the dimensions (in millimetres) of the stator of the SRM in FIG. 1.

FIG. 3 is a sectional drawing showing the dimensions (in millimetres) of a rotor of the SRM in FIG. 1.

FIG. 4 is a sectional drawing showing the stator in FIGS. 1 and 2 enclosed in a motor yoke.

FIG. 5 is a sectional drawing of the stator and the motor yoke in FIG. 4, further showing a stator winding around each stator pole of the stator.

FIG. 6 is a sectional drawing of the SRM in FIG. 1 showing a pair of diametrically opposite rotor poles in alignment with a pair of diametrically opposite stator poles in a minimum reluctance position thereof, and current directions in the windings for rotating the rotor in an anti-clockwise direction.

FIG. 7 is a sectional drawing similar to FIG. 6 showing current directions in the windings for rotating the rotor in clockwise direction.

FIG. 8A is a schematic drawing showing flux pulsation between a stator pole and a rotor pole of an SRM without any permanent magnet in its stator poles.

FIG. 8B is a schematic drawing showing flux pulsation between a stator pole and a rotor pole of the SRM in FIG. 1 wherein the stator pole has a permanent magnet disposed therein so as to manipulate the direction of magnetic flux generated in the stator pole.

FIG. 9 is a sectional drawing of a motor assembly including the SRM in FIG. 1.

FIG. 10 are sectional drawings of stator poles having permanent magnets of different shapes located in various positions therein according to other embodiments of the invention.

### DETAILED DESCRIPTION

It is to be understood that this invention is not limited to particularly exemplified systems and parameters that may, of course vary. It is also to be understood that the terminology used herein is for the purpose of describing particular embodiments of the invention only and is not intended to limit the scope of the invention in any manner.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

The terms “braking torque”, “magnetic torque” and “cogging torque” may be interchangeably used to describe the no-current torque due to the interaction between the permanent magnets of the stator poles and the rotor.

The term, “remanent flux density or remanence” refers to the value of flux density remaining when the external field returns from the high value of saturation magnetization to zero or near zero. The remanence is also called the residual magnetization.

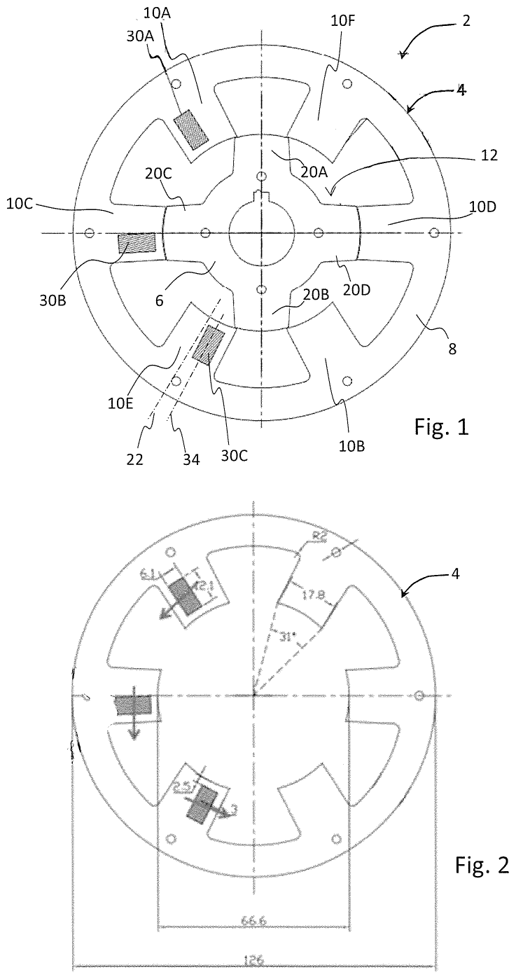

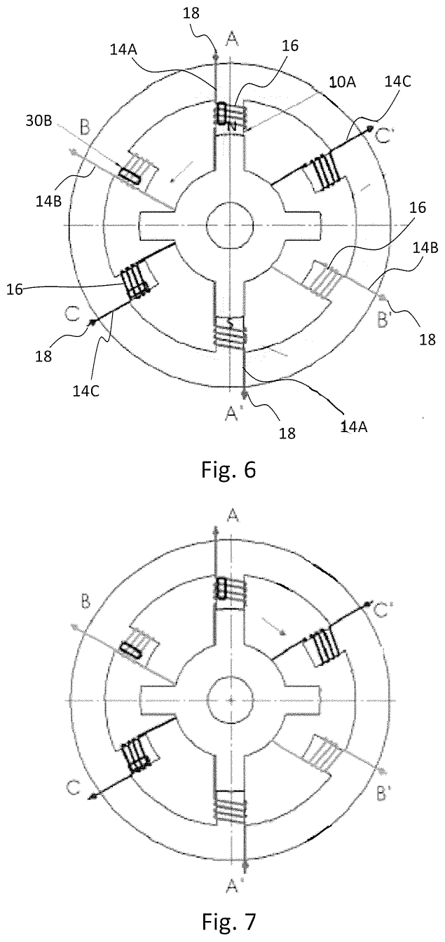

As shown in the drawings for purposes of illustration, the invention may be embodied in a stator of a motor that has reduced torque ripple and acoustic noise. Referring to FIGS. 1 to 7, a stator embodying the invention generally includes a stator including two or more pairs of diametrically opposite stator poles and two or more stator windings. Each stator winding is wound around each pair of diametrically opposite stator poles. The winding can be energized to generate magnetic flux within one stator pole of the pair of diametrically opposite stator poles along a radial axis thereof. The magnetic flux emanates out of a face of the stator pole. The stator further includes a permanent magnet disposed in the stator pole for diverting the magnetic flux to emanate at least substantially from a side surface of the stator pole. The invention may further be embodied in a motor having the stator.

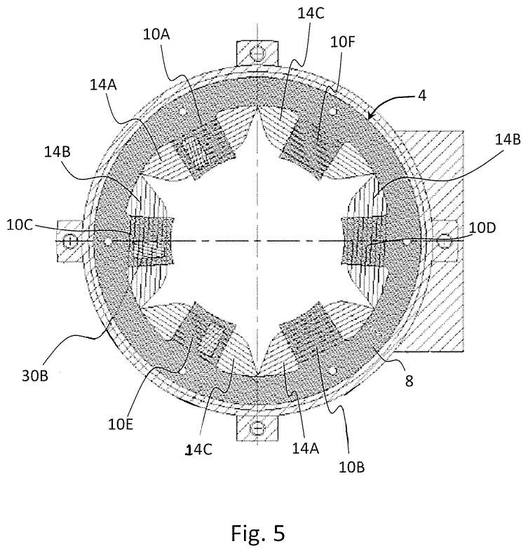

Specifically, FIGS. 1-7 show a switched reluctance motor (SRM) 2 including a stator 4 and a rotor 6. The stator 4 includes a cylindrical stator yoke 8 and three pairs of diametrically opposite stator poles 10A-10F projecting inwardly from the stator yoke 8. The stator 4 includes an opening 12 therein surrounded by the stator poles 10A-10F. The stator 4 further includes three stator windings 14A-14C (FIGS. 5-7). Winding 14A is wound around a first pair of stator poles 10A, 10B to define a first phase A of the SRM 2. Winding 14B is wound around a second pair of stator poles 10C, 10D to define a second phase B of the SRM 2. Winding 14C is would around a third pair of stator pole 10E, 10F to define a third phase C of the SRM 2. In a winding 14A-14C for a pair of stator poles 10A-10F, the coils 16 around a stator pole 10A, 10B, 10C in each pair of stator poles 10A-10F are connected in series with coils around the other stator pole 10D, 10E, 10F in the pair of stator poles 10A-10F In this manner, there are a total of six wire ends 18 leading out of the SRM 2 that are connected to the output of a motor drive (not shown) for supplying electric current therethrough.

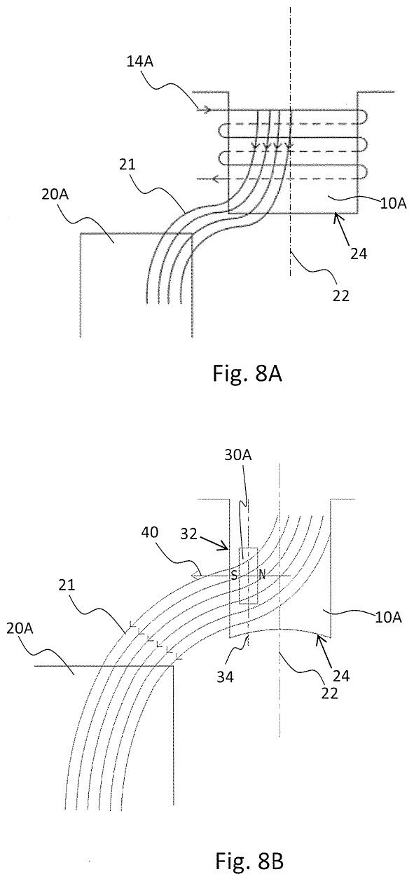

The rotor 6 is received in the opening 12 of the stator 4 to be rotatable therein. The rotor 6 includes two pairs of diametrically opposite rotor poles 20A-20D. The rotor 6 is a laminated structure without any permanent magnet. In use, each winding 14A-14C is energized in turn by passage of an electric current therethrough. When a winding 14A-14C is energized, magnetic flux is generated in the corresponding pair of stator poles 10A-10F to excite the pair of stator poles 10A-10F In this manner, the magnetic flux 21 (FIG. 8A) is generated along a radial axis 22 of a start of phase stator pole 10A-10C to emanate out of a face 24 (FIG. 8A) of the stator pole 10A-10C. In such a magnetic circuit, the rotor 6 is urged to come to a position of minimum reluctance at the instance of excitation of the stator poles 10A-10F FIG. 1 shows a pair of rotor poles 20C, 20D aligned with a pair of excited stator poles 10C, 10D. In this position, the other pair of rotor poles 20A, 20B are out of alignment with respect to the other pairs of stator poles 10A, 10B, 10E, 10F.

To reduce torque ripple and acoustic noise, and improve the efficiency of the SRM 2, the stator 4 further includes three permanent magnets (PM) 30A-30C. A PM 30A-30C is disposed in the start of phase stator pole 10A-10C for diverting the magnetic flux 21 to emanate at least substantially from a side surface 32 (FIG. 8B) of the stator pole 10A-10C. Preferably, at least about 70% of the magnetic flux 21 emanates from the side surface 32 of the stator pole 10A-10C. In some embodiments, as high as 100% of the magnetic flux 21 emanates from the side surface 32 of the stator pole 10A-10C.

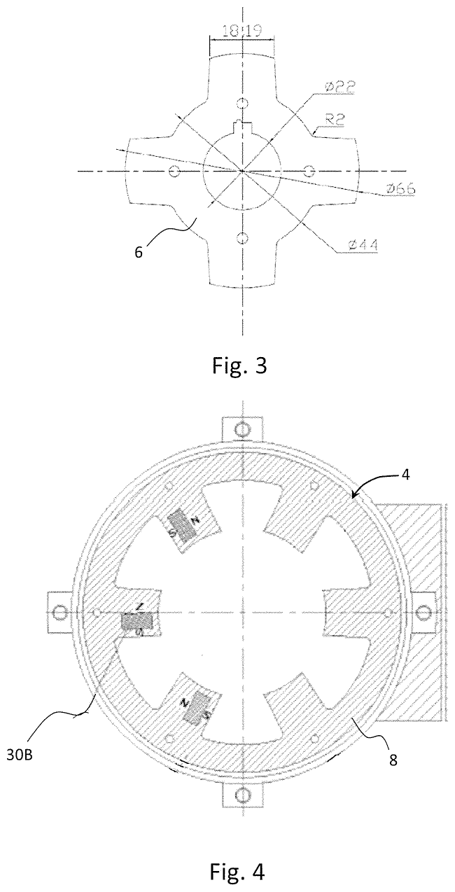

FIGS. 2 and 3 show exemplary dimensions in millimetres (mm) of the stator 4 and the rotor 6 respectively. FIG. 2 also shows exemplary cross-sectional dimensions of the PMs 30A-30C. Each PM 30A-30C has a rectangular cross section measuring 12.1 mm×6.1 mm. However, the width or thickness of a PM 30A-30C may be in the range of about 5-7 mm.

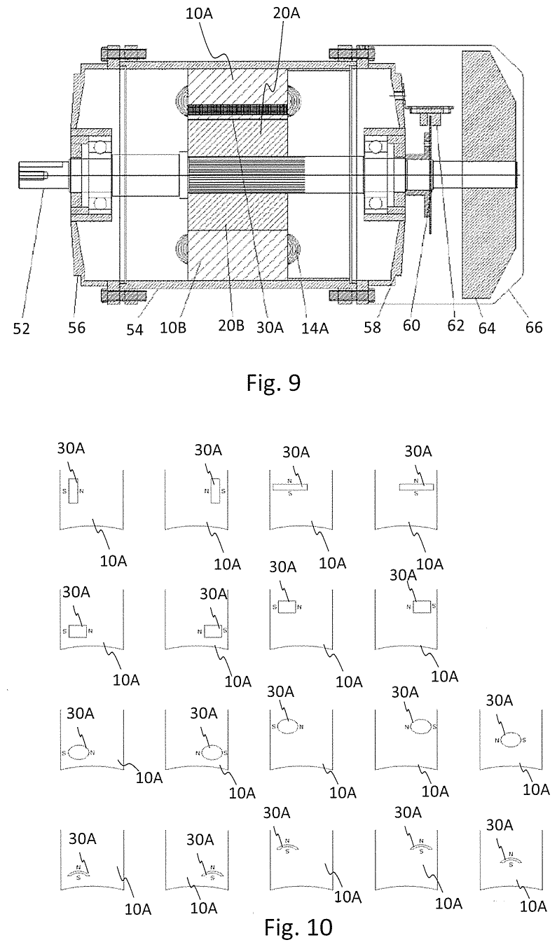

As per motor current and temperature rise the permanent magnet volume is calculated. A rectangular shape slot (not shown) extending through the entire length of each of the stator poles 10A-10C (FIG. 9) having a volume corresponding to the calculated volume of the magnet is provided in the stator poles 10A, 10C, 10E. And the correspondingly shaped elongated PMs 30A-30C are inserted into the rectangular shape slots of the stator poles 10A, 10C, 10E. As is known to those skilled in the art, PMs of other shapes, including but not limited to square, circular, oval, trapezoidal, arcuate, semi-circular, etc as shown in FIG. 10, may also be used. In this embodiment, each PM 30A-30C is the sole magnet 30A-30C in a respective stator pole 10A, 10C, 10E. In other words, each PM 30A-30C is the one and only magnet 30A-30C present in a respective stator pole 10A, 10C, 10E. Each PM 30A-30C is disposed in a respective stator pole 10A, 10C, 10E offset from the radial axis 22. More specifically, the PM 30A-30C has an intermediate axis 34 (FIGS. 8A, 8B) that is spaced apart from the radial axis 22 of the stator pole 10A, 10C, 10E. The PM 30A-30C is oriented in the slot such that an N-pole of the PM 30A-30C faces inwardly, i.e. towards the radial axis 22 to have a direction of magnetism (DOM) 40 intersecting the radial axis 22 of the stator pole 10A, 10C, 10E. Preferably, the PM 30A-30C has a DOM 40 that is close to perpendicular, e.g. 80-89 degrees or perpendicular to the radial axis 22 of the stator pole 10A, 10C, 10E.

The other stator pole 10B, 10D, 10F of the pair of diametrically opposite stator poles 10A-10F is preferably void of any PM as shown in FIG. 1. Therefore, only one stator pole 10A, 10C, 10E of each pair of stator poles 10A-10F has a PM 30A-30C therein. For the first pair of stator poles 10A, 10B, only the stator pole 10A has the PM 30A therein. For the second pair of stator poles 10C, 10D, only the stator pole 10C has the PM 30B therein. And for the third pair of stator poles 10E, 10F, only the stator pole 10E has the PM 30C. The stator poles 10A, 10C, 10E having the PMs 30A-30C therein are adjacent to one another. In other words, the three consecutive stator poles 10A, 10C, 10E each have a PM 30A-30C therein. The stator poles 10B, 10D, 10F void of any PM are therefore also adjacent to one another as shown in FIG. 1.

In this embodiment, each PM 30A-30C includes a non-rare earth ferrite PM although other types of permanent magnets may also be used. Each PM 30A-30C preferably has a remanent flux density (Br) in the range of between about 0.31T and about 0.35T and delivers a magnetic flux density of about 0.29T. As mentioned above, the shape of the PMs 30A-30C can be of any geometrical shape or any unconventional shape. Each PM 30A-30C may be a relatively low-cost magnet available in the market.

Each PM 30A-30C may be of grades ranging from a Y8T grade with a 0.2T flux density to a Y40 grade with a flux density of 0.44T. The choice of the PM 30A-30C can be based on the motor power capacity and the desired amount of torque ripple reduction. In some embodiments, the SRM 2 may have a rating of between 0.5 kW and 100 kW. For a lower motor rating of 0.5 kW, a Y8T grade PM which increases the flux linkage and reduces the torque ripple may be used. If a Y40 grade PM is used for such a motor rating of 0.5 kW, the higher flux density might cause braking torque which requires additional reluctance torque to overcome. To choose the desired remanent flux density the rule of thumb is to arrive at 20% of stator pole 10A-10F peak flux density. For example, if the stator pole has 1.5T peak flux density, the remanent or residual flux density of the PM may be approximately 20% of stator flux density, i.e. about 0.3T.

Parameters like dimensions, shape and position of a PM will determine its direction of magnetism (DOM). The magnet parameters will therefore have to be appropriately selected to facilitate the manipulation of the flux path in the stator pole 10A, 10C, 10E. Details of the selection of parameters of the PMs 30A-30C will be described later.

Due to the presence of the PMs 30A-30C in the stator poles 10A, 10C, 10E, a flux density of 0.29T is readily available in the stator 4. This imparts an initial residual flux in the stator 4. This residual flux helps in starting of the SRM 2 by eliminating the starting problem in the SRM 2 and reducing the flux pulsation and torque ripple during operation of the SRM 2. The turning of the rotor 6 thereafter causes a rise in inductance of the windings 14A-14C as the windings 14A-14C are magnetically energized. This eliminates the initial surge of flux pulsation thereby reducing the ripples and magnetic noise during phase reversal to a fairly significant level.

Further, due to the placement of the PMs 30A-30C in the stator poles 10A, 10C, 10D, the total magnetomotive force (MMF) required from a source (not shown) is reduced, thereby reducing the power demand of a system including the motor and the drive. Reduced MMF makes the stator and rotor lamination operate at average operating flux densities at each section, thereby reducing the iron and copper loss of the SRM 2. As MMF is provided/boosted by the PMs 30A-30C, the number of turns of each phase winding 14A-14C is reduced. This results in reduced copper weight, copper losses and improves efficiency.

The introduction of PMs 30A-30C in the stator poles 10A, 10C, 10E also enhances the resultant torque/output torque of the SRM 2. The increase in the Torque per unit rotor volume (TRV) facilitates reduction of the size of the SRM 2 both in diameter and length for producing the same torque output. Each stator winding 14A-14C is preferably of copper wire of 22 standard wire gauge (SWG), i.e. about 0.711 per wire strand with 4 wire strands and less than 20 turns per winding. To achieve the same torque capacity in an SRM without any PM, the wire size will have to be 21.5 SWG with 4 wire strands and 25 turns per winding.

Torque performance with saturation is given by:

$$T ( 0 , i ) = \frac{1}{2} i ( {θ}^{2} ) \frac{dL ( θ , i )}{d θ}$$

$${L}_{1} ( θ , i ) = \frac{N {∅}_{m , 1}}{i ( θ )} = \frac{N}{i ( θ )} {∅}_{coil , 1}$$

$${L}_{2} ( θ , i ) = \frac{N , {∅}_{m , 2}}{i ( θ )} = \frac{N}{i ( θ )} ( {∅}_{c o i l , 2} + {∅}_{pm} )$$

where N is the number of turns of the winding per pole,
Ø_{coil,1} is the flux of a winding in an SRM without any PM,
Ø_{coil,2} is the flux of a winding 14A-14C in a permanent-magnet-assisted SRM 2 described above, and
Øₚₘ is the flux of a PM 30A-30C in the permanent-magnet-assisted SRM 2 described above.

As discussed above, the inclusion of the PMs 30A-30C introduces braking torque or cogging torque in the SRM 2 thereby demanding higher starting current during starting of the SRM 2. This braking torque reduces the average output torque.

Each PM 30A-30C may be positioned or placed at a distance of about 2.5 mm from the face 24 of a respective stator pole 10A, 10C, 10E to avoid magnetic saturation and demagnetization at the rectangular slot and to provide mechanical support. It mitigates, minimizes or eliminates the flux reversal thereby mitigating the torque ripple. But this causes higher braking torque. In order to overcome the braking torque, the position of PM 30A-30C and shape of PM 30A-30C is found to play a crucial role. When the PM 30A-30C is placed away from the face 24 of the stator pole 10A, 10C, 10E as described, the braking torque is reduced.

In the invention the PMs 30A-30C can be of any shape and the position of the magnet can be from start of the phase or end of the phase of the stator pole, vertical towards the right of the stator pole, vertical towards the left of the stator pole, horizontal towards the left of stator pole, horizontal towards the right of the stator pole, at a center of the stator pole, midway along the length of the stator pole, towards the face of the stator pole, away from the face of the stator pole, etc. as shown in FIG. 10.

As mentioned above, the position and shape of a PM 30A-30C determines its direction of magnetism (DOM). Introduction of the PMs 30A-30C in the stator poles 10A, 10C, 10E leads to a change of flux path in the stator poles 10A, 10C, 10E. FIG. 8A shows the path of magnetic flux in a stator pole 10A, 10C, 10E without any PM when a rotor pole 20A-20D is approaching the stator pole 10A, 10C, 10E. It can be seen that the magnetic flux is still very much emanating from the face 24 of the stator pole 10A, 10C, 10E. FIG. 8B shows the path of magnetic flux in a stator pole 10A, 10C, 10E with the introduction of a PM 30A-30C having a DOM 40 close to perpendicular or perpendicular to the radial axis 22 of the stator pole 10A, 10C, 10E as described above. The path of the magnetic flux is diverted to substantially emanate from a side surface 32 of the stator pole 10A, 10C, 10E when the rotor pole 20A-20D is approaching the stator pole pole 10A, 10C, 10E. It is evident from FIGS. 8A, 8B that the path of the magnetic flux in the stator pole 10A, 10C, 10E is changed. The magnetic flux does not cut the stator and rotor tooth in direction of torque. This method of manipulating the flux path with varying direction of magnetization (DOM) mitigates the magnetic torque or braking torque without influencing the torque output of the SRM. Thus, it is possible to reduce torque ripple, and have a high average torque, a low starting current with high starting torque and an improved system efficiency using standard control logic by the introduction of the PMs 30A-30C in the SRM 2.

A motor assembly 50 including the SRM 2 is next described with the aid of FIG. 9. The motor assembly includes a shaft 52 inserted through a hollow centre of the rotor 6 to be thereby fixedly attached thereto. When the rotor 6 rotates, the shaft is 52 thereby rotated. The SRM 2 is housed in a cylindrical motor yoke 54. A first end of the motor yoke 54 is covered by a front cover 56. A second end of the motor yoke 54 is covered by a rear cover 58. Ends of the shaft 52 protrudes the front cover 56 and rear cover 58. A sensor disc 60 is fixedly attached to an end section of the shaft 52 protruding from the rear cover 58. An infra-red (IR) sensor 62 is mounted to the rear cover 58 over the sensor disc 60 for detecting rotation of the shaft 52. Fixed to an end of the shaft 52 that protrudes from the rear cover 58 is a cooling fan 64. A cooling fan cover 66 is placed over the rear cover 58 to enclose the sensor disc 60, the IR sensor 62 and the cooling fan 64.

Advantageously, the SRM 2 having the stator 4 with the PMs 30A-30C introduced therein as described above is able, to some extent, to overcome the problems of high torque ripple and acoustic noise. The SRM 2 is observed to have an increase in power density and efficiency while eliminating the issues associated with the introduction of the PMs 30A-30C like cogging torque and the motor starting problem.

Compared to an SRM without any PM, the torque ripple of the above-described SRM 2 with the PMs 30A-30C may be reduced by as much as 33-40%. And the acoustic noise may be reduced by as much as 28-35%. The efficiency of the SRM without any PM is 79% while the efficiency above-described SRM 2 with the PMs 30A-30C ranges between 82-90%.

A method of manufacturing the above-described SRM 2 is next described. The method includes providing the above-described stator 4 having slots (not shown) in selected stator poles 10A, 10C, 10E. The method further includes inserting a PM 30A-30C into each slot of the stator poles 10A, 10C, 10E. The method further includes placing a winding 14A-14C around each pair of diametrically opposite stator poles 10A-10F As described above, the winding 14A-14C is energizable to generate magnetic flux within a stator pole 10A, 10C, 10E of the pair of diametrically opposite stator poles 10A-10F along a radial axis 22 of the stator pole 10A, 10C, 10E to emanate out of a face 22 thereof. However, with the introduction of the PMs 30A-30C, the magnetic flux in the stator pole 10A, 10C, 10E is diverted by each PM 30A-30C to emanate at least substantially from a side surface 32 of the stator pole 10A, 10C, 10E. Preferably, the other stator pole 10B, 10D, 10F of the pair of diametrically opposite stator poles 10A-10F is void of any magnet as described above.

Experimental results obtained for a 6/4 pole 3-phase SRM 2 is next described. The specifications of the SRM 2 is depicted in Table 1 below. The windings 14A-14C of the SRM 2 is of copper wire of 22 SWG, and 20 turns per winding 14A-14C. A rectangular ferrite permanent magnet 30A-30C of a Y21H grade having cross-sectional dimensions of a length of 12.1 mm, and a width of 6.1 mm is used. Each PM 30A-30C is positioned at a distance of 2.5 mm from a pole face 24 of a respective stator pole 10A, 10C, 10E. The PMs 30A-30C are placed in three consecutive stator poles 10A, 10C, 10E of a 6-pole stator as seen in FIG. 1 for three phase operation to produce a torque of 2.9 N-m.

Each stator pole 10A, 10C, 10E has a width is 17.8 mm. With a width of 6.1 mm, the PM 30A-30C therefore has a width that is 34% of the width of the stator pole 10A, 10C, 10E. Such a proportion is chosen to avoid saturation of stator pole 10A, 10C, 10E before peak power load of the SRM 2 is reached. Other width proportions of around 30-40% will also work.

TABLE 1
Specifications of a 3-phase 600 W switched
reluctance motor 2.

| SI. No | Particulars | Value | Unit |
|---|---|---|---|
| 1 | Motor Shaft Power | 830 | W |
| 2 | Rated Voltage Vdc | 48 | V |
| 3 | Supply Current Idc | 20.5 | A |
| 4 | Motor Efficiency | 84 | % |
| 5 | Rated Speed | 2700 | RPM |
| 6 | Rated Torque | 2.94 | N-m |
| 7 | Configuration | 6/4 pole | |
| 8 | Phase | 3 | |
| 9 | Insulation Class | F class | |
| 10 | Sensor Type | IR | |

The torque ripple of an SRM without any PM is 14% and the torque ripple of the SRM with PMs disposed therein as described above is found to be 9%. This works out to an approximately 36% reduction in torque ripple.

The acoustic noise of the SRM 2 with PMs 30A-30C is 63 dB, which is 30% lower than the 90 dB acoustic noise generated in the SRM without any PM.

Table 2 shows the improvement in torque ripple and acoustic noise in the 3-phase 600 W SRM 2 compared to an SRM without any PM.

| | Torque Ripple | Acoustic Noise |
|---|---|---|
| | (%) | (dB) |
| SRM without any PM | 14% | 90 |
| SRM 2 (with PMs) | 9% | 63 |
| Percentage Improvement | 35.71% | 30.00% |

An electronic test equipment such as, but not limited to an LCR meter, is used to measure the winding inductance at different rotor positions. This helps to identify the flux linkage at every micro rotor stepping.

First the inductance of the SRM without PM is measured by injecting a small amount of current in the region of milli-amperes (mA) in a stator winding. The inductance profile is obtained for various rotor positions. This inductance profile is the signature of the motor. It directly provides the flux linkage of the motor at various rotor positions.

Next, the same steps are repeated for the SRM 2 with PMs 30A-30C. The inductance values at different rotor positions are plotted. A clear change in magnetic flux from 0T to 0.29T is observed in the SRM 2 after incorporation of the PMs 30A-30C.

Although the present invention is described as implemented in the above described embodiment, it is not to be construed to be limited as such. For example, the invention is described in the context of a switched reluctance motor (SRM). The invention may however be used in any motor, for example a BLDC motor.

As another example, the invention is described in the context of a 6/4 pole switched reluctance motor. The invention may also be used in switched reluctance motors of other configurations, such as but not limited to, a switch reluctance motor having two or more pairs of diametrically opposite stator poles.

As yet a further example, a single magnet is described to be disposed in a stator pole. It is envisaged that more than one magnet may be used in a stator pole to divert the magnetic flux as described above.

As yet another example, the PM is described to be disposed in a start of phase stator pole. Those skilled in the art will recognise that the PM may also be disposed in an end of phase stator pole leaving the corresponding start of phase stator pole void of any magnet.

1. A stator comprising:
at least two pairs of diametrically opposite stator poles;
at least two stator windings, each stator winding wound around each pair of diametrically opposite stator poles which when energized generates magnetic flux within a stator pole of the pair of diametrically opposite stator poles along a radial axis of the stator pole to emanate out of a face thereof; and
a permanent magnet disposed in the stator pole offset from the radial axis and having an N-pole facing the radial axis and a direction of magnetism intersecting the radial axis of the stator pole for diverting the magnetic flux to emanate at least substantially from a side surface of the stator pole;
wherein the other pole of the pair of diametrically opposite stator poles is without any permanent magnet.

2. The stator according to claim 1, wherein the permanent magnet has a direction of magnetism that is at least close to perpendicular to the radial axis.

3. The stator according to claim 1, wherein the permanent magnet is the sole magnet disposed in the stator pole.

4. The stator according to claim 1, wherein stator poles of the at least two pairs of diametrically opposite stator poles having a permanent magnet disposed therein are adjacent to one another.

5. The stator according to claim 1, wherein the permanent magnet is a non-rare earth ferrite permanent magnet.

6. A motor comprising:
a stator comprising:
at least two pairs of diametrically opposite stator poles;
at least two stator windings, each stator winding wound around each pair of diametrically opposite stator poles which when energized generates magnetic flux within a stator pole of the pair of diametrically opposite stator poles along a radial axis thereof to emanate out of a face of one of the pair of diametrically opposite stator poles; and
a permanent magnet disposed in the stator pole offset from the radial axis and having an N-pole facing the radial axis and a direction of magnetism intersecting the radial axis of the stator pole for diverting the magnetic flux to emanate at least substantially from a side surface of the stator pole; wherein the other pole of the pair of diametrically opposite stator poles is without any permanent magnet; and
a rotor rotatable under the influence of the magnetic flux, the rotor comprising at least one pair of diametrically opposite rotor poles.

7. The motor according to claim 6, wherein the permanent magnet has a direction of magnetism that is at least close to perpendicular to the radial axis.

8. The motor according to claim 6, wherein the permanent magnet is the sole magnet disposed in the stator pole.

9. The motor according to claim 6, wherein stator poles of the at least two pairs of diametrically opposite stator poles having a permanent magnet disposed therein are adjacent to one another.

10. The motor according to claim 6, wherein the permanent magnet is a non-rare earth ferrite permanent magnet.

11. A vehicle comprising:
a motor comprising:
a stator comprising:
at least two pairs of diametrically opposite stator poles;
at least two stator windings, each stator winding wound around each pair of diametrically opposite stator poles which when energized generates magnetic flux within a stator pole of the pair of diametrically opposite stator poles along a radial axis thereof to emanate out of a face of one of the pair of diametrically opposite stator poles; and
a permanent magnet disposed in the stator pole offset from the radial axis and having an N-pole facing the radial axis and a direction of magnetism intersecting the radial axis of the stator pole for diverting the magnetic flux to emanate at least substantially from a side surface of the stator pole; wherein the other pole of the pair of diametrically opposite stator poles is without any permanent magnet; and
a rotor rotatable under the influence of the magnetic flux, the rotor comprising at least one pair of diametrically opposite rotor poles.

12. The vehicle according to claim 11, wherein the permanent magnet has a direction of magnetism that is at least close to perpendicular to the radial axis.

13. The vehicle according to claim 11, wherein the permanent magnet is the sole magnet disposed in the stator pole.

14. A method of manufacturing a stator comprising at least two pairs of diametrically opposite stator poles, the method comprising:
placing a winding around each pair of the at least two pairs of diametrically opposite stator poles, the winding being energizable to generate magnetic flux within a stator pole of the pair of diametrically opposite stator poles along a radial axis of the stator pole to emanate out of a face thereof; and
inserting a permanent magnet in the stator pole for diverting the magnetic flux to emanate at least substantially from a side surface of the stator pole, leaving the other stator pole of the pair of diametrically opposite stator poles without any magnet.

15. The method according to claim 14, wherein stator poles of the at least two pairs of diametrically opposite stator poles having a permanent magnet inserted therein are adjacent to one another.

16.-22. (canceled)
